(19) United States
(12) Patent Application Publication
(10) Pub. No.: US 2024/0309524 A1
(43) Pub. Date: Sep. 19, 2024

(54) CATALYST FOR SOLAR-DRIVEN ELECTROCATALYTIC OVERALL WATER SPLITTING AND METHODS OF MAKING AND USING THEREOF

(71) Applicant: City University of Hong Kong, Hong Kong (CN)

(72) Inventors: Johnny Chung Yin HO, Hong Kong (CN); Quan QUAN, Hong Kong (CN); Yuxuan ZHANG, Hong Kong (CN); Wei WANG, Hong Kong (CN)

(73) Assignee: City University of Hong Kong, Hong Kong (CN)

(21) Appl. No.: 18/183,288

(22) Filed: Mar. 14, 2023

(51) Int. Cl. C25B 11/077; C25B 9/17; C25B 11/054; C25B 11/061; C25B 11/065

(52) U.S. Cl. CPC C25B 11/077; C25B 9/17; C25B 11/054; C25B 11/061; C25B 11/065

(57) ABSTRACT

Electrocatalytic overall water splitting to generate hydrogen and oxygen is a green and sustainable approach with zero carbon emission, which is important for the future renewable energy landscape. The practical application of this approach is challenging due to the sluggish reaction kinetics of water activation at high current densities, which are hard to overcome. Although high-performance alkaline bifunctional electrocatalysts may be useful, current catalysts lack both activity and durability. One approach is to rationally design bifunctional two-dimensional (2D) heterostructures but obtaining an efficient and durable catalyst has proved difficult. The present disclosure relates generally to an electrocatalyst including a 2D heterostructure (Ru-CMOP), methods of making and using the same. The catalyst of the present disclosure is designed for high activity and good durability at industrial-level high current densities.

### FIELD

The present disclosure relates generally to electrochemical overall water splitting and. more specifically, to catalysts for solar-driven electrochemical overall water splitting and methods of making and using thereof.

### BACKGROUND

Electrocatalytic overall water splitting to generate hydrogen and oxygen is a green and sustainable approach with zero carbon emission. However, the sluggish reaction kinetics of water activation are challenging to overcome and current catalysts lack good efficiency and durability at large current densities. Efficient strategies to realize high-performance alkaline bifunctional electrocatalysts for industrial-scale water-splitting devices are currently lacking.

Heterostructure construction via judiciously designing heterointerfaces has emerged as an effective method to promote intrinsic activity for surface-mediated electrochemical reactions. For example, a two-dimensional (2D) nanosheet structure with a high specific surface area increases the accessible surfaces during the liquid-phase catalytic reaction. A 2D phosphide-based heterostructure may be obtained through a partial phosphorization treatment to construct an assembler with the generated phosphide onto the surface of 2D metal-based precursors. However, the phosphide bulks have a high surface energy and generally huddle on the surface of the 2D precursor, which creates another integrated surface by shielding the interfacial heterojunctions from participating in chemical reactions and limiting the reaction kinetics.

### SUMMARY

The present disclosure offers advantages, benefits, and other alternatives over known compositions and methods, by providing a catalyst for solar-driven electrochemical overall water splitting, methods of making and using thereof, that are efficient and durable.

In an aspect, provided is a method of making a catalyst including: (i) forming a plurality of Ru-doped CoMoO₄ nanosheets on a support by a solvothermal process; and (ii) treating the plurality of Ru-doped CoMoO₄ nanosheets with a phosphorous source to create phosphide nanodomains, wherein the solvothermal process includes providing a support, mixing a Co source, a Mo source, and a Ru source to form a first solution; heating the solution and support together at a temperature in the range from about 160 to 180° C. for about 10 to 12 hours; and cooling the supported CoMoO₄ nanosheets to room temperature.

In an example, the support may be a nickel foam or a carbon fiber paper. In another example, the Co source may be a water-soluble cobalt salt, such as cobalt nitrate hexahydrate (Co(NO₃)₂·6H₂O). In yet another example, the Mo source may be a water-soluble molybdate salt, such as ammonium molybdate tetrahydrate ((NH₄)₆Mo₇O₂₄·4H₂O). In a further example, Ru source may be ruthenium chloride hydrate (RuCl₃·ₓH₂O).

In an example, treating the plurality of Ru-doped CoMoO₄ nanosheets with a phosphorous source to create phosphide nanodomains may include annealing the supported Ru-doped CoMoO₄ nanosheets and a phosphorous source at a temperature in the range from about 280 to 300° C. for about 1 to 2 hours under Ar atmosphere at a ramping rate of about 5° C. min-1 and cooling to room temperature. In another example, the phosphorous source may be a hypophosphite, such as sodium hypophosphite NaH₂PO₂. In yet another example, the phosphide nanodomains may have an average diameter of about 4 to about 8 nm. In still another example, the treated Ru-doped CoMoO₄ nanosheet array may have a thickness of about 10 to 15 nm.

In an aspect, provided is a catalyst including: a support, a plurality of Ru-doped CoMoO₄ nanosheets arrays assembled on the support, and a plurality of phosphide nanodomains on the Ru-doped CoMoO₄ nanosheet arrays. In an example, (i) the support may be a nickel foam or a carbon fiber paper; (ii) the phosphide nanodomains may have an average diameter of about 4 to 8 nm; and (iii) the catalyst may have a thickness of about 10 to 15 nm.

In as aspect, provided is an electrolyzer including a cathode including Ru-CMOP and an anode including Ru-CMOP. In an example, the electrolyzer may further include a solar cell. In another example, the Ru-CMOP may include: a support; a plurality of Ru-doped CoMoO4 nanosheet arrays assembled on the support; and a plurality of phosphide nanodomains on the Ru-doped CoMoO₄ nanosheet arrays. In yet another example, (i) the support may be a nickel foam or a carbon fiber paper, (ii) the phosphide nanodomains may have an average diameter of about 4 to 8 nm; and (iii) the catalyst may have a thickness of about 10 to 15 nm. In still another example, the Ru-CMOP may exhibit (i) overpotentials of about 114±5 mV at −100 mA cm⁻² and about 183±10 mV at −500 mA cm⁻² for hydrogen evolution reaction; and (ii) overpotentials of about 286±5 mV at 100 mA cm⁻² and about 351±10 mV at 500 mA cm⁻² for oxygen evolution reaction. In a further example, the Ru-CMOP may be durable at about 250±10 mA cm⁻² for about 100 to 120 hours.

### BRIEF DESCRIPTION OF THE FIGURES

These and other features, aspects, and advantages of the present disclosure will become better understood when the following detailed description is read with reference to the accompanying drawings, wherein:

FIG. 1 is a schematic illustration of the preparation process of Ru-COMP;

FIG. 2A is a scanning electron microscopy (SEM) image of the bare nickel foam;

FIG. 2B is an SEM image of the Ru-CMOP nanosheet arrays grown on nickel foam;

FIG. 2C is an enlarged SEM image of the area in FIG. 2B marked by the dotted box;

FIG. 2D is a transmission electron microscopy (TEM) image of Ru-CMOP with an inset TEM image of a typical Ru-CMOP nanosheet;

FIG. 2E is a high-resolution transmission electron microscopy (HRTEM) image of Ru-CMOP with insets of selected area electron diffraction (SAED) patterns and facet spacing details;

FIG. 3A is an x-ray diffraction (XRD) pattern of Ru-CMOP;

FIG. 3B is a depth-profiling x-ray photoelectron spectroscopy (XPS) spectra of P 2p for Ru-CMOP after Ar ion etching with different duration;

FIG. 3C is a high-resolution XPS for Ru 3d spectra coupled with C 1 s spectra of Ru-CMOP and Ru-CMO;

FIG. 3D is a high-resolution XPS for Co 2p spectra of Ru-CMOP and Ru-CMO;

FIG. 3E is a differential charge density of Ru-CMO an Ru-CMOP, where the contours represent electron accumulation (Δρ=+0.007e×bohr⁻³) and depletion (Δρ=+0.007e×bohr⁻³);

FIG. 4A depicts polarization curves for hydrogen evolution reaction (HER) and oxygen evolution reaction (OER) in 1 M KOH solution;

FIG. 4B is a graph of the overpotentials of CMO, Ru-CMO, CMOP, Ru-CMOP, and Pt/C at different current densities for HER performance;

FIG. 4C is a Tafel plot for HER performance of the examples in FIG. 4B;

FIG. 4D is a graph of the overpotentials of CMO, Ru-CMO, CMOP, Ru-CMOP, and Pt/C at different current densities for OER performance;

FIG. 4E is a Tafel plot for HER performance of the examples in FIG. 4D;

FIG. 4F depicts chronopotentiometry (CP) curves of Ru-CMOP without iR correction at −250 mA cm⁻² and 250 mA cm⁻²;

FIG. 4G is a graph comparing overpotentials at −100/100 mA cm⁻² with the reported phosphide-based bifunctional heterostructures;

FIG. 5A is a graph of polarization curves conducted on a two-electrode configuration for overall water splitting in 1.0 M KOH;

FIG. 5B is a potential comparison of different current densities for overall water splitting;

FIG. 5C is a CP curve of Ru-CMOP∥Ru-CMOP couple without iR correction at 250 mV cm⁻²;

FIG. 5D is a schematic illustration of Ru-CMOP nanosheet for overall water splitting;

FIG. 5E is a digital photograph of an electrolyzer driven by a silicon solar cell; and

FIG. 5F is a magnified photograph of a two-electrode setup using an Ru-CMOP∥Ru-CMOP couple and the electrodes during a reaction.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### DETAILED DESCRIPTION

According to an aspect of the present disclosure, there is provided a controllable phosphorization process to in-situ produce ultrafine Ru-doped CoMoP nanodomains (Ru-CMP) uniformly dispersed on the Ru-doped CoMoO₄ nanosheet arrays (Ru-CMO) to construct a heterostructure (denoted as Ru-CMOP) for highly efficient overall water splitting at high current density. Using this method, (i) the generated ultrafine Ru-CMP nanodomains with uniform distribution can activate the basal planes and create rich phase boundaries on 2D Ru-CMO nanosheets to increase the number of active sites; (ii) the created heterointerfaces can form a built-in electric field and the active Ru species can also optimize the electronic structure, synergistically facilitating the electron transfer; and (iii) the interconnected heterostructured nanosheet assemble as 3D multi-porous arrays can expedite the continuously produced gas bubble escape from the active sites to strengthen mechanical stability.

For the construction of a heterointerface, the charge accumulation is generated at the two phases. In other words, a highway for continuous electron transport between the two phases is established. Therefore, constructing strong heterointerfaces can facilitate the electron transfer within the 2D heterostructure to accelerate the efficiency of electrocatalytic water splitting.

The surface chemical configuration of 2D heterostructures may be designed to transform the inert basal planes into abundant active sites. For example, elaborately downsizing secondary phosphide building blocks onto the surface of nanosheet precursors (e.g., nanodomain modulation) provides a feasible approach for designing a 2D phosphide-based heterostructure with abundant phase boundaries and exposed active sites to boost the surface-mediated reaction kinetics. The freestanding 2D heterostructure nanosheets or nanoplates generally possess a loose structure and tend to aggregate at high temperatures or during the catalytic process with the desorption of adsorbed species or functional groups. 3D porous micro-nanostructure, with high electrical conductivity and tunable porous structure, may be used as a substrate (e.g., commercial nickel foam (NF)) under proper surface modification to build highly active electrocatalysts. Growing vertically aligned 2D heterostructure nanosheets on the skeleton of NF can form a uniform 3D array structure, which features abundant multi-level porosity as open channels for mass diffusion and gas release, thereby endowing a large contact area with electrolyte to further promote the electrocatalytic activity and preventing structure destruction from the bubble accumulation to strengthen the mechanical stability. Therefore, the growth of 2D heterostructures on well-conductive substrates directly served as electrodes may make commercial use applicable.

The as-obtained Ru-CMOP exhibits a hydrogen evolution reaction (HER) activity with overpotentials of 114 and 183 mV at −100 and −500 mA cm⁻², respectively, and an oxygen evolution reaction (OER) activity with overpotentials of 286 and 351 mV at 100 and 500 mA cm⁻², respectively. The electrocatalyst also has long-term stability under strong reducing/oxidating conditions. Additionally, when employed as a bifunctional catalyst for alkaline water splitting, the Ru-CMOP delivers cell voltages of 1.697 V and 1.828 V at 100 mA cm⁻² and 500 mA cm⁻², respectively, with outstanding durability at 250 mA cm⁻² for 120 h. Further, a solar-cell-driven overall water-splitting device is constructed to demonstrate its effective and robust practical operation.

### Synthesis and Characterization of Ru-CMOP Heterostructure

According to an aspect of the present disclosure, there is provided a method of making a catalyst, including forming a plurality of Ru-doped CoMoO₄ nanosheets on a support by a solvothermal process, and treating the plurality of Ru-doped CoMoO₄ nanosheets with a phosphorous source to create phosphide nanodomains. In another example, the solvothermal process includes providing a support, mixing a Co source, a Mo source, and a Ru source to form a first solution, heating the solution and support together at a temperature in the range from about 160 to 180° C., including all ranges and subranges therein, e.g., about 160° C. to about 170° C., about 170° C. to about 180° C., about 160° C. to about 165° C., about 165° C. to about 170° C., about 170° C. to about 175° C., about 175° C. to about 180° C., etc., for about 10 to 12 hours, including all ranges, subranges, and values therein, e.g., about 10 hours to about 11 hours, about 11 hours to about 12 hours, about 10 hours to about 10.5 hours, about 10.5 hours to about 11 hours, about 11 hours to about 11.5 hours, about 11.5 hours to about 12 hours, etc., and cooling the supported CoMoO₄ nanosheets to room temperature.

In an example, the support may be a nickel foam or a carbon fiber paper. In another example, the Co source may be a water-soluble cobalt salt. Non-limiting examples of a water-soluble cobalt salt include cobalt nitrate hexahydrate (Co(NO₃)₂·6H₂O), cobalt chloride hexahydrate (CoCl₂·6H₂O), and the like. In yet another example, the Mo source may be a water-soluble molybdate salt. Non-limiting examples of water-soluble molybdate salt include ammonium molybdate tetrahydrate (NH₄)₆Mo₇O₂₄·4H₂O), sodium molybdate dihydrate (Na₂MoO₄·2H₂O), and the like. In still another example, the Ru source may be ruthenium chloride hydrate (RuCl₃·ₓH₂O).

In an example, treating the plurality of Ru-doped CoMoO₄ nanosheets with a phosphorous source to create phosphide nanodomains includes annealing the supported Ru-doped CoMoO₄ nanosheets and a phosphorous source at about 280 to 300° C., including all ranges and subranges therein, e.g., about 280° C. to about 290° C., about 290° C. to about 300° C., about 280°° C. to about 285° C., about 285° C. to about 290°° C., about 290° C., to about 295° C., about 295° C. to about 300° C., etc., for about 1 to 2 hours, including all ranges, subranges, and values therein, e.g., about 1 hour to about 1.5 hours, about 1.5 hours to about 2 hours, etc., under Ar atmosphere at a ramping rate of about 5° C. min¹ and cooling to room temperature.

In an example, the phosphorous source is may be a hypophosphite. Non-limiting examples of a hypophosphite include sodium hypophosphite (NaH₂PO₂), potassium hypophosphite (KH₂PO₂), and the like.

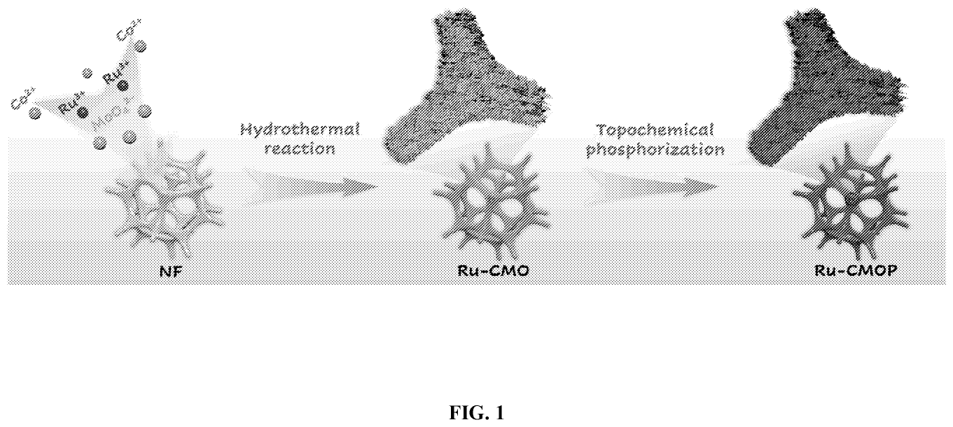

The Ru-CMOP heterostructure may be synthesized through a facile two-step procedure, an example of which is illustrated in FIG. 1. The Ru-doped CoMoO₄ nanosheet arrays (Ru-CMO) may be grown on nickel foam (NF) via a hydrothermal reaction with precisely controlled Ru doping, then subjected to a controllable phosphorization treatment through a facile gas-solid reaction. As a result, the Ru doped CoMoP nanodomains (Ru-CMP) are generated in-situ on the surface of Ru-CMO nanosheets.

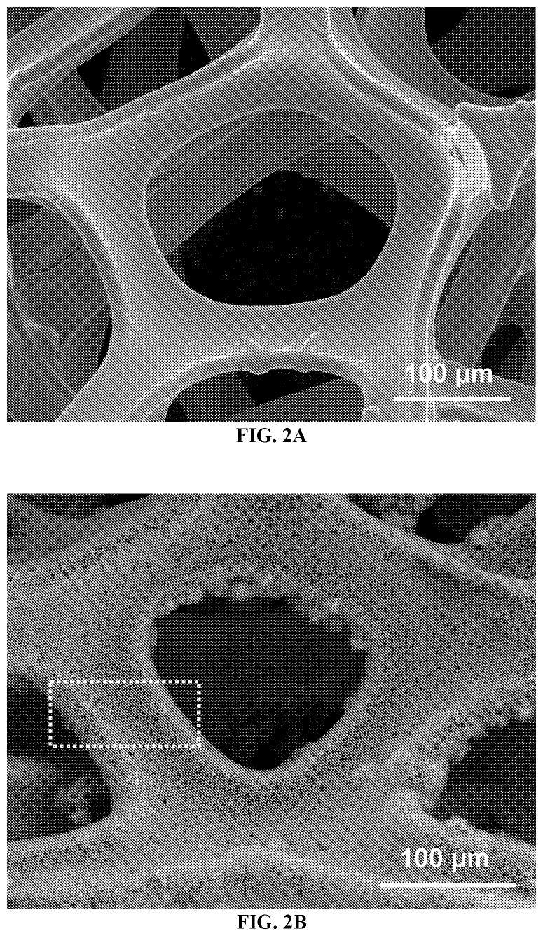

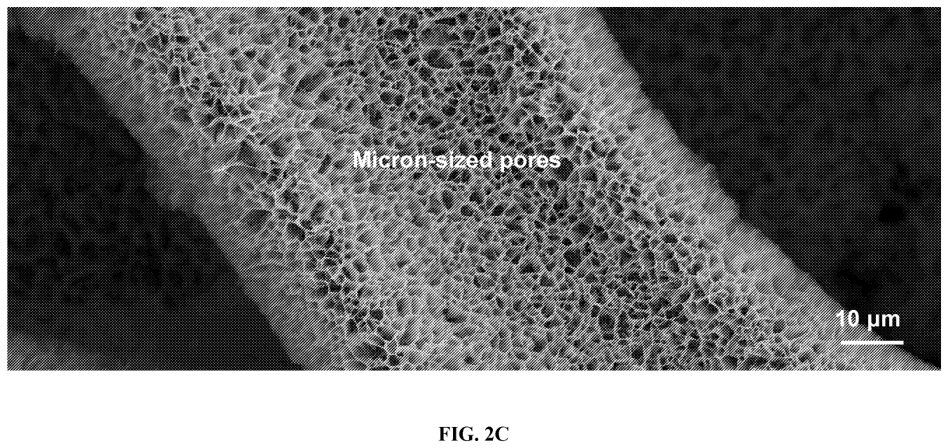

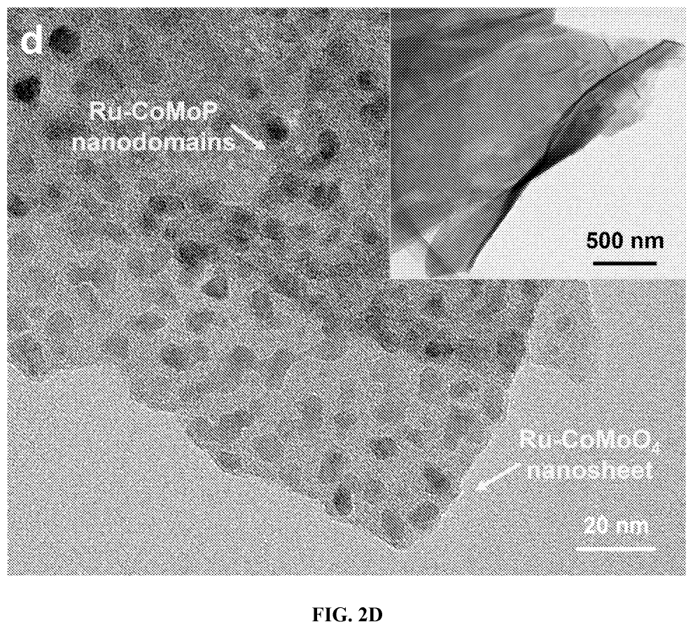

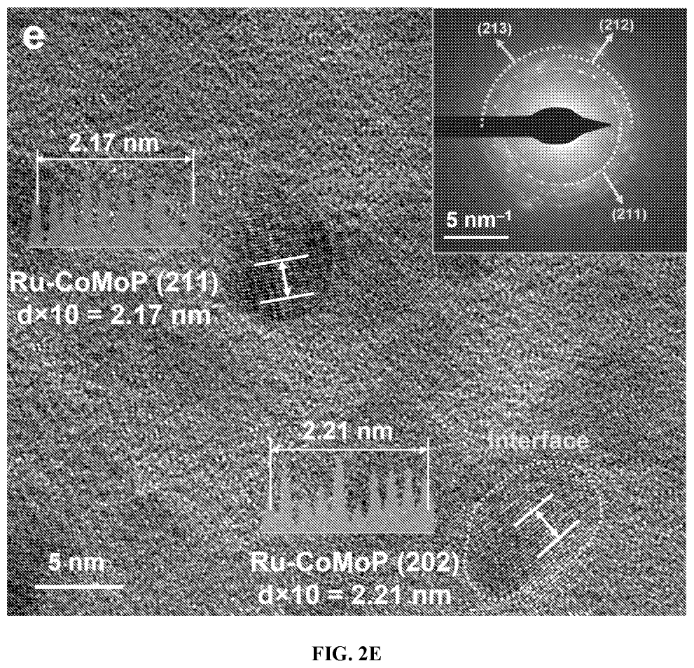

Scanning electron microscopy (SEM) images of as-obtained Ru-CMOP exhibit a uniform 3D array structure assembled by vertically aligned 2D heterostructure nanosheets on the skeleton of NF (FIG. 2A and FIG. 2B). Abundant spatial voids exist among the interconnected nanosheets, which are well-inherited from the structure of the Ru-CMO precursor (FIG. 2C), contributing to the fast mass transfer and gas release during the electrocatalytic reaction. Observed from transmission electron microscopy (TEM) images of the Ru-CMOP nanosheet, Ru-CMP nanodomains with a dark contrast can be readily distinguished, revealing that they are uniformly dispersed on the Ru-CMO phase with a large number of phase boundaries and distinct heterointerfaces (FIG. 2D). The nanodomains have an average diameter of about 4 to 8 nm, including all ranges, subranges, and values therein, e.g., about 4 nm to about 6 nm, about 6 nm to about 8 nm, about 4 nm to about 5 nm, about 5 nm to about 6 nm, about 6 nm to about 7 nm, about 7 nm to about 8 nm, about 4 nm, about 4.5 nm, about 5 nm, about 5.5. nm, about 6 nm, about 6.5 nm, about 7 nm, about 7.5 nm, about 8 nm, etc., and the thickness of the Ru-CMOP heterostructure is about 10 to 15 nm, including all ranges, subranges, and values therein, e.g., about 10 nm to about 11 nm, about 11 nm to about 12 nm, about 12 nm to about 13 nm, about 13 nm to about 14 nm, about 14 nm to about 15 nm, about 10 nm, about 11 nm, about 12 nm, about 13 nm, about 14 nm, about 15 nm, etc. In FIG. 2E, the high-resolution TEM (HRTEM) image of the nanodomains exhibits the interplanar spacings of 0.217 and 0.221 nm, corresponding to the (211) and (202) planes of Ru-CoMoP crystals. The corresponding selected area electron diffraction (SAED) image illustrates the polycrystalline nature of the phosphatized nanodomains. In this regard, for the controllable phosphorization process, regulated PH₃ gas with a low dose derived from the decomposition of NaH₂PO₂ attacks the lattice of Ru-CMO precursor at the gas-solid interface. Then, the P atoms partially substitute the lattice O to generate the Ru-CMP nanodomains on the Ru-CMO sheet surface, thereby forming the 2D mosaic heterostructure with rich phase boundaries and heterointerfaces.

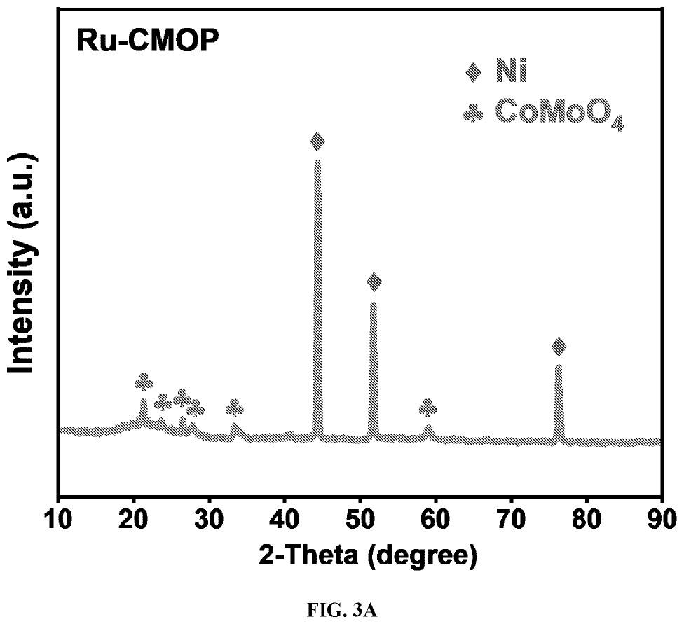

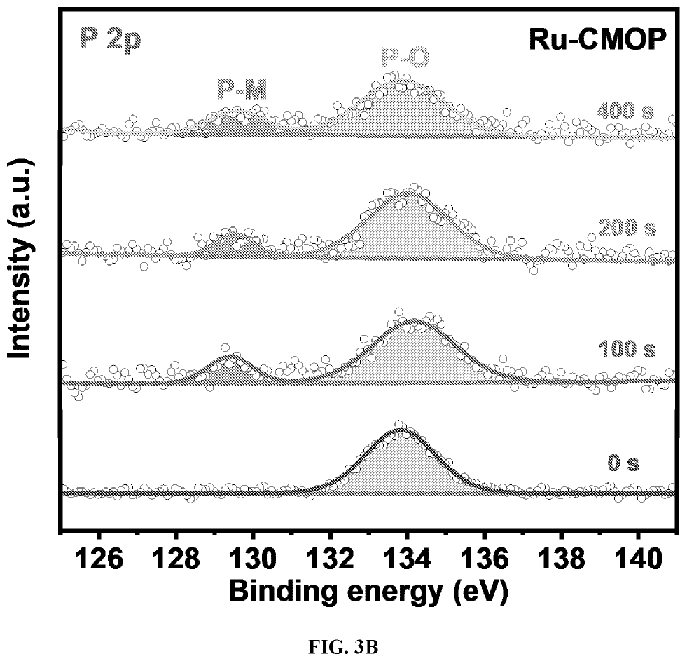

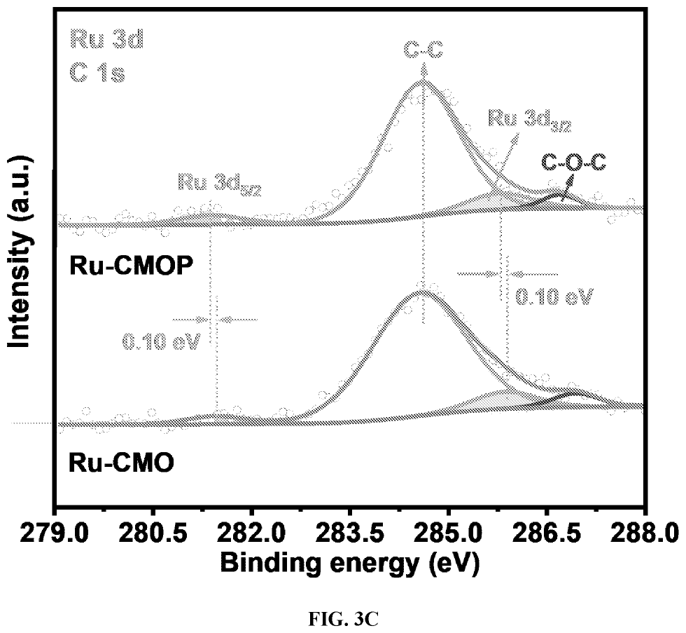

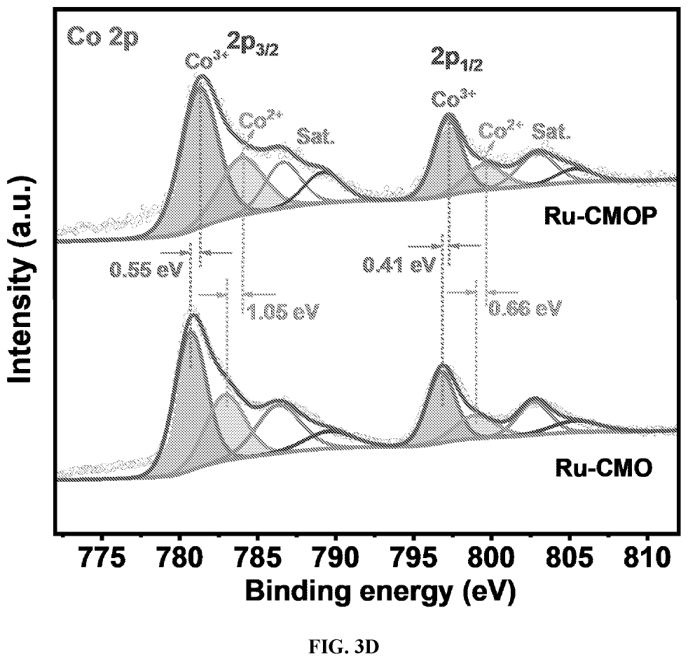

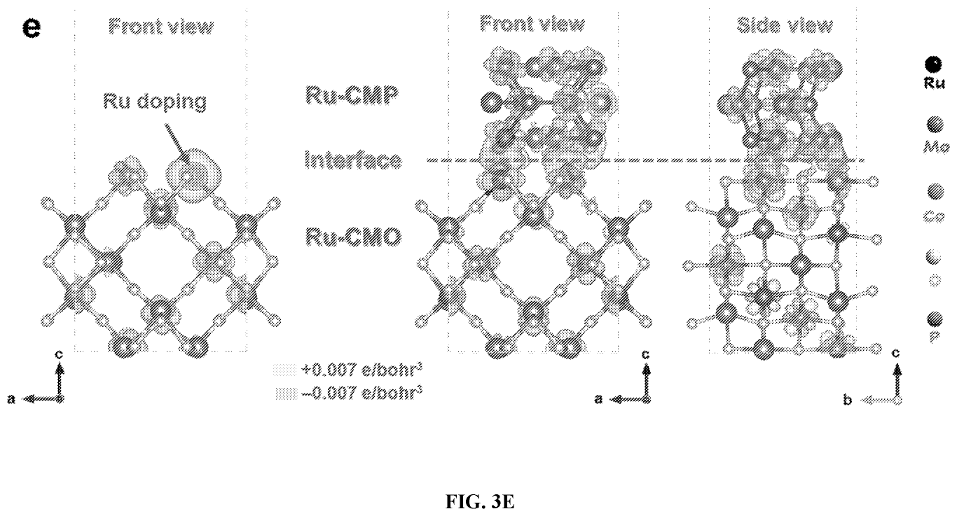

The X-ray diffraction (XRD) result of the Ru-CMOP sample displays the pattern of the CoMoO₄ besides the strong peaks of metallic Ni skeleton (FIG. 3A). Notably, there are no peaks ascribed to the ultra-fine Ru-CMP nanodomains, suggesting their good dispersion on the 2D Ru-CMO support, in line with the results of TEM characterizations. For the depth-profiling XPS spectra of P 2p (FIG. 3B), only the P—O peak signal is detected due to the inevitable surface oxidation of metal phosphides resulting from the exposure to air. Then, the P-M (M=Co, Mo, Ru) bond at around 129.5 eV appears after the Ar ion sputtering and remains unchanged as the sputtering duration increases, indicating the Ru-CMP nanodomains embedded in the Ru-CMO nanosheet skeleton. FIG. 3C deconvolutes C 1 s and Ru 3d peaks in Ru-CMOP and Ru-CMO. The detected C 1s peaks originated from the carbon tape used in the XPS test and the contamination with environmental carbon. The binding energies of Ru 3d_{5/2} and Ru 3d_{3/2} peaks of the Ru-CMOP sample are centered at 281.38 and 285.78 eV, respectively, which is a slight shift towards lower binding energies as compared to those of Ru-CMO (Ru 3d_{5/2}/Ru 3d_{3/2}: 281.48 cV/285.88 cV). The high-resolution Co 2p spectra of the two samples can be deconvoluted into two spin-orbit doublets and two shakeup satellites (denoted as “Sat.”) (FIG. 3D). For the Ru-CMOP, the first doublet at 781.24 and 783.96 eV and the second at 797.18 and 799.58 eV are attributed to Co 2p_{3/2} and Co 2p_{1/2}, respectively. It is observed that the phosphorization treatment leads to an upshift behavior of the Co 2p spectra for Ru-CMOP as compared to those of Ru-CMO. Moreover, the Mo 3d and O 1 s peaks also exhibit positive shifts as compared to the Ru-CMO precursor. These results signify the charge redistribution occurs after the formation of Ru-CMP nanodomains due to the strong interfacial interaction.

To further illustrate this, the differential charge density is calculated to identify the charge distribution on the Ru-CMO and Ru-CMOP (FIG. 3E). For the Ru-CMO, an accumulation charge density can be visualized around the Ru doping atoms in the CMO lattice. After the addition of Ru-CMP on Ru-CMO, a charge accumulation is observed at the interface between Ru-CMO and Ru-CMP, indicating the formation of a built-in electric field near the heterointerface, which establishes the highway of continuous electron transport between the two phases. Those results demonstrate that the Ru doping and Ru-CMP assembling could induce the redistribution of the electronic structure, which results in the enhanced electron circumstances for catalyzing the electrocatalytic reaction.

According to an aspect of the present disclosure, there is provided a catalyst including a support, a plurality of Ru-doped CoMoO₄ nanosheet arrays (Ru-CMO) assembled on the support; and a plurality of phosphide nanodomains (Ru-CMP) on the Ru-doped CoMoO4 nanosheet arrays. In an example, the support may be a nickel foam or a carbon fiber paper. In another example, the phosphide nanodomains may have an average diameter of about 4 to 8 nm, including all ranges, subranges, and values therein, e.g., about 4 nm to about 6 nm, about 6 nm to about 8 nm, about 4 nm to about 5 nm, about 5 nm to about 6 nm, about 6 nm to about 7 nm, about 7 nm to about 8 nm, about 4 nm, about 4.5 nm, about 5 nm, about 5.5. nm, about 6 nm, about 6.5 nm, about 7 nm, about 7.5 nm, about 8 nm, etc. In yet another example, the thickness of the Ru-CMOP heterostructure is about 10 to 15 nm, including all ranges, subranges, and values therein, e.g., about 10 nm to about 11 nm, about 11 nm to about 12 nm, about 12 nm to about 13 nm, about 13 nm to about 14 nm, about 14 nm to about 15 nm, about 10 nm, about 11 nm, about 12 nm, about 13 nm, about 14 nm, about 15 nm, etc. In an example, the catalyst is made by the method described hereinabove.

### HER and OER Performance in Alkaline Media

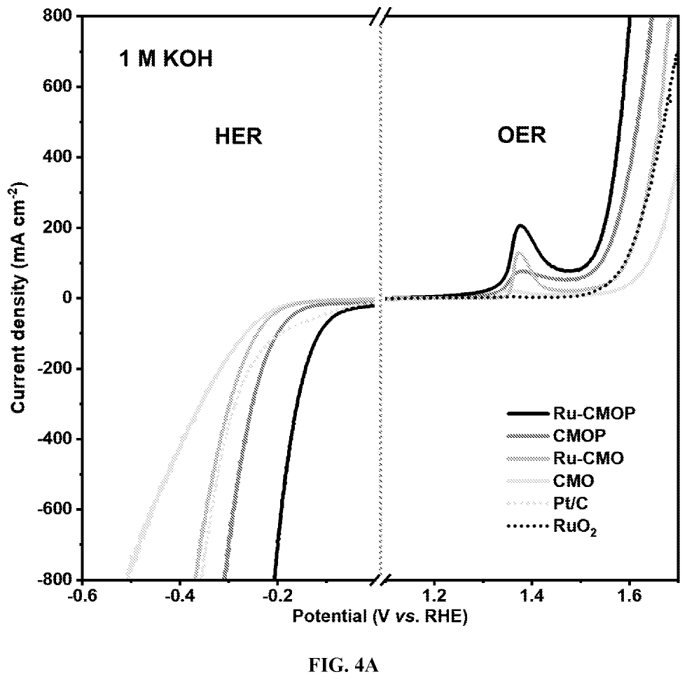

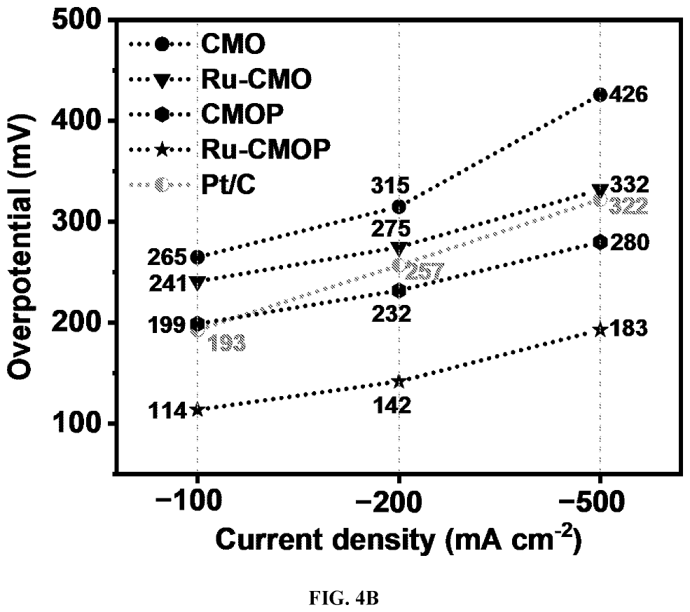

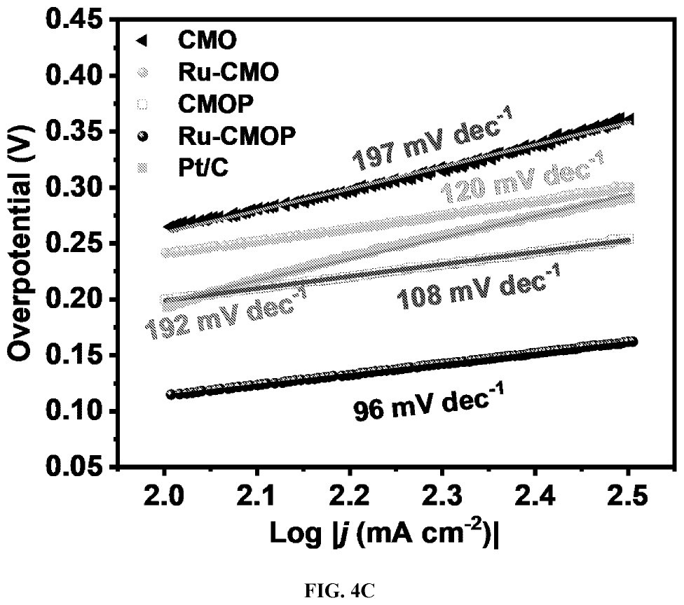

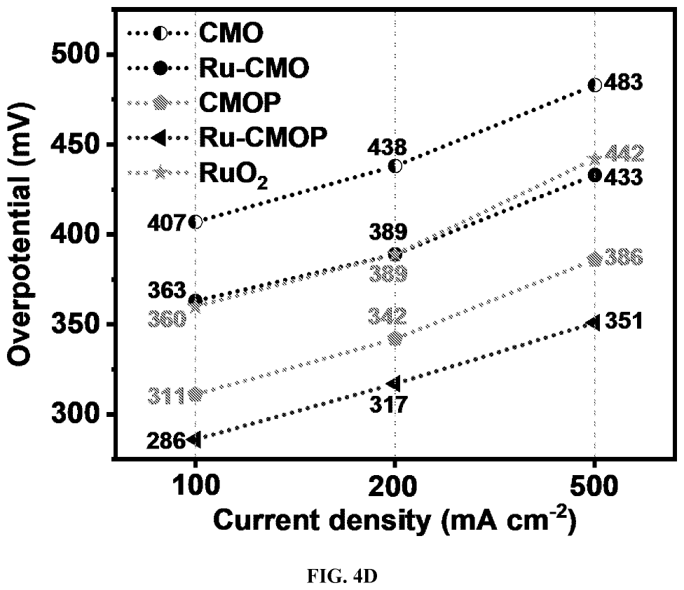

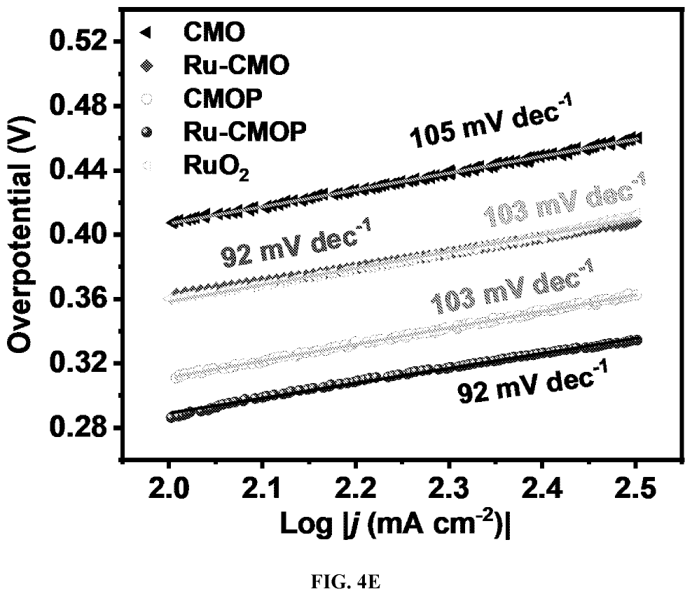

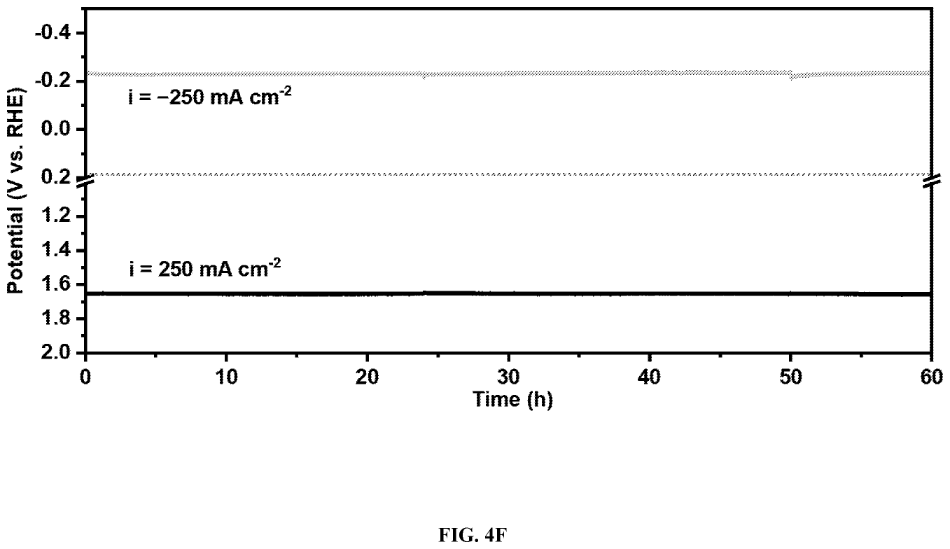

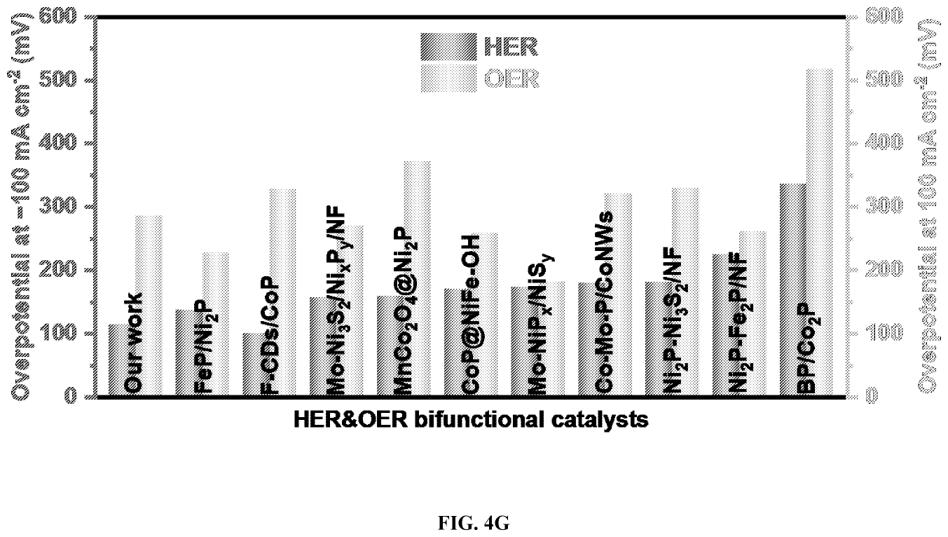

The HER performance of the as-obtained Ru-CMOP is evaluated in an Ar-saturated 1.0 M KOH aqueous solution with a typical three-electrode system. Samples of Ru-CMO, CMOP, and CMO as counterparts and Pt/C as a benchmark are measured under identical conditions for comparison. The polarization curves of the tested catalysts for HER are presented in FIG. 4A. As a result, the Ru-CMOP exhibits significantly superior HER performance than the comparative samples, especially in high current density. Specifically, in comparison of CMOP (199, 232, and 280 mV), Ru-CMO (241, 275, and 332 mV), CMO (265, 315, and 426 mV), and Pt/C (193, 257, and 322 mV), Ru-CMOP delivers the current densities of 100, 200, and 500 mA cm⁻² at the low overpotentials of 114, 142 and 183 mV, respectively (FIG. 4B). As shown in FIG. 4C, the Tafel slope of Ru-CMOP exhibits the lowest value of 96 mV dec⁻¹ as compared with those of CMOP (108 mV dec⁻¹), Ru-CMO (120 mV dec⁻¹), CMO (197 mV dec⁻¹), and Pt/C (192 mV dec⁻¹), indicating the rapid kinetics of Ru-CMOP owing to the introduction of Ru dopant and the generation of ultrafine Ru-CMP nanodomains.

Afterward, the stability of Ru-CMOP for HER activity is evaluated via a chronopotentiometry (CP) curve at −250 mA cm⁻² for 60 h. As displayed in FIG. 4F, there is no large potential change in this strong reducing environment for a long duration. The morphology of post-Ru-CMOP subjected to the HER stability test is well-sustained in the nanosheet-array structure, suggesting the structural stability of the 3D architecture assembled from the 2D heterostructure nanosheets.

In the following, the OER performance of the catalysts is investigated in the Ar-saturated 1.0 M KOH solution via the three-electrode system. The commercial RuO₂ is applied as a benchmark sample. As shown in FIG. 4A, the polarization curves of the tested catalysts indicate the Ru-CMOP possesses the best catalytic activity toward the OER. In the comparison of CMOP (311, 342, and 386 mV), Ru-CMO (363, 389, and 433 mV), CMO (407, 438, and 483 mV), and RuO₂ (360, 389, and 442 mV), Ru-CMOP delivers the current densities of 100, 200, and 500 mA cm⁻² at the low overpotentials of 286, 317 and 351 mV, respectively (FIG. 4D). In FIG. 4E, the Tafel slope of the Ru-CMOP is calculated to be 92 mV dec⁻¹, which is equal to that of Ru-CMO (92 mV dec⁻¹) and lower than those of CMOP (103 mV dec⁻¹), CMO (103 mV dec⁻¹), and RuO₂ (105 mV dec⁻¹). This result demonstrates that the Ru doping contributes to the favorable kinetics for OER.

Moreover, the Ru-CMOP shows decent stability at 250 mA cm⁻² for 60 h without any noticeable degradation in the alkaline media (FIG. 4F). Additionally, as shown in FIG. 4G, the electrocatalytic activity of Ru-CMOP for both HER and OER in alkaline solution outperforms most of the reported phosphide-based bifunctional heterostructures, suggesting that Ru-CMOP is a promising candidate for overall water splitting.

### Overall Water Splitting Application

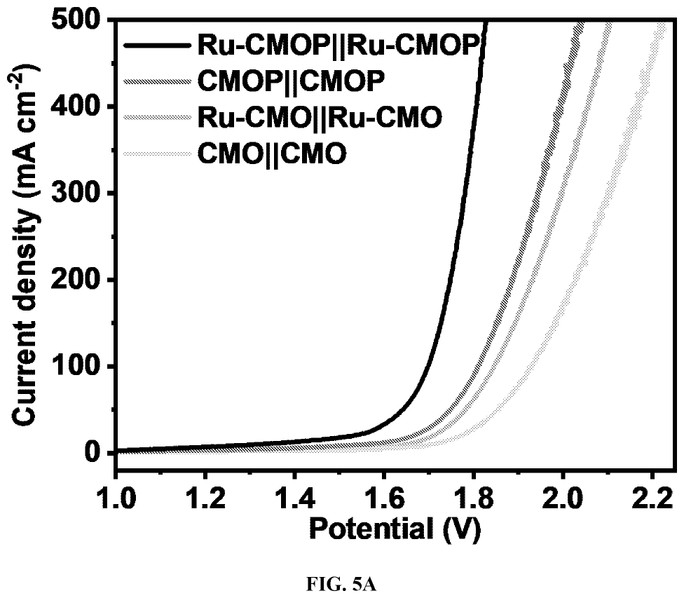

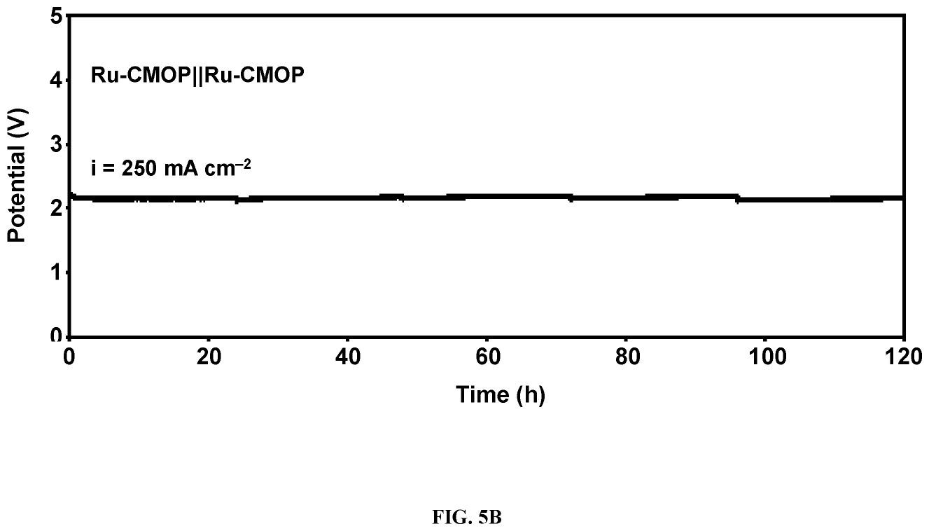

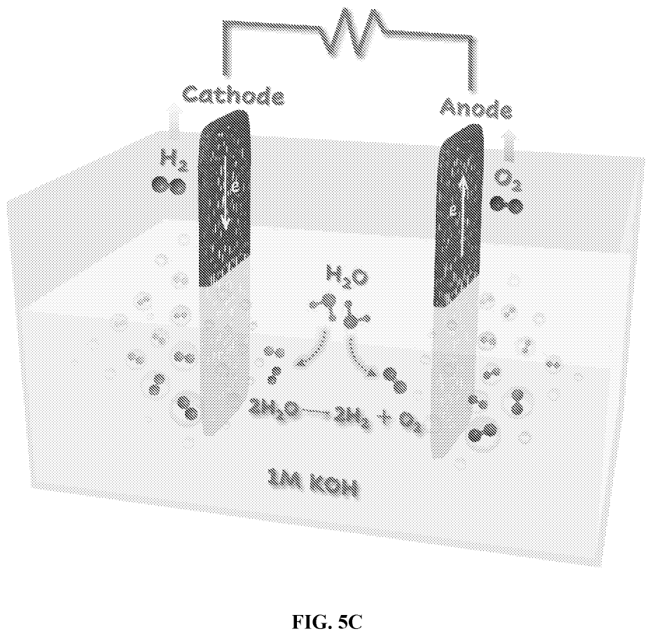

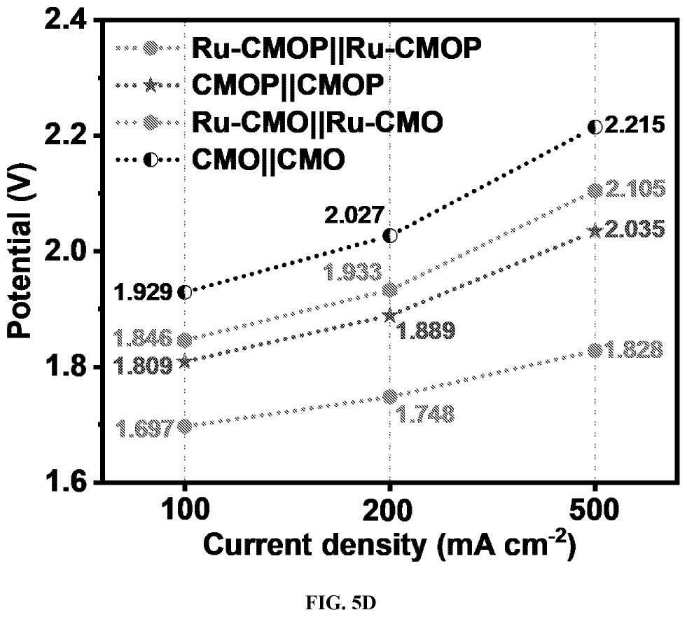

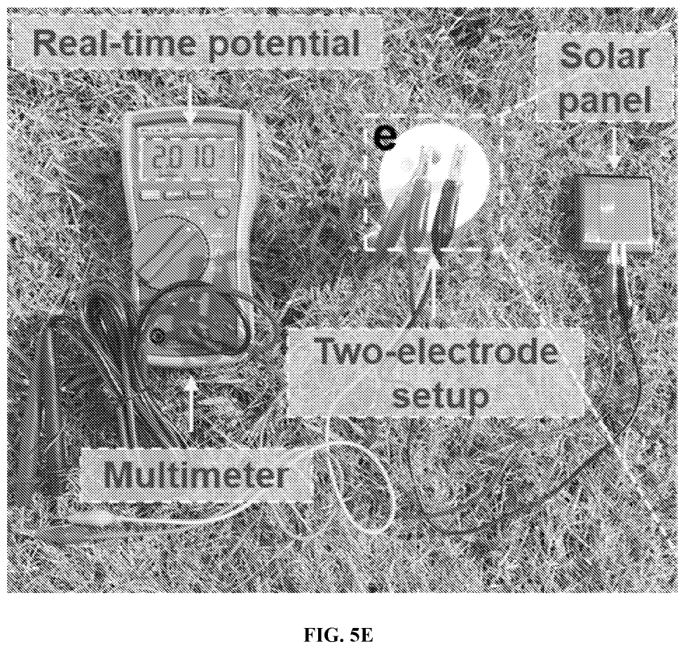

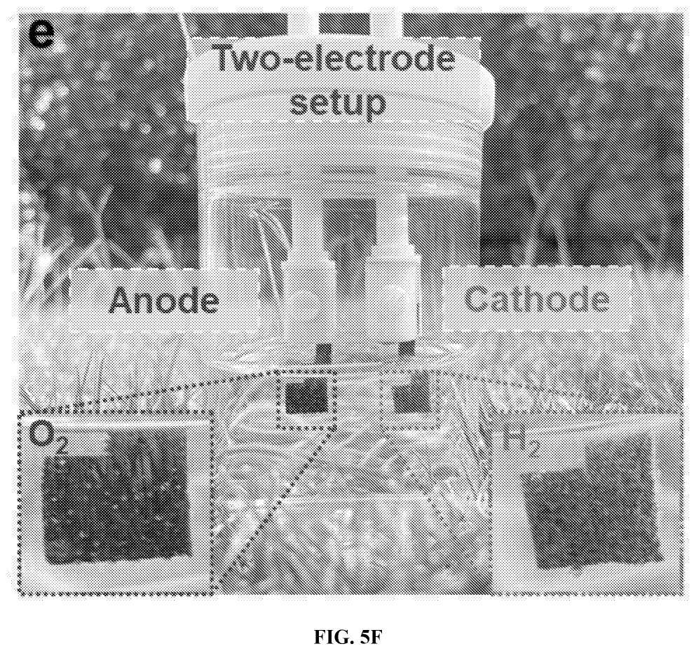

A two-electrode configuration using Ru-CMOP as both anode and cathode is built for overall water splitting in 1.0 M KOH electrolyte, which is denoted as Ru-CMOP∥Ru-CMOP. Similarly, the CMOP∥CMOP, Ru-CMO∥Ru-CMO, and CMO∥CMO two-electrode configurations are also constructed for comparison. As shown in FIG. 5A, the Ru-CMOP∥Ru-CMOP exhibits the smallest cell voltage of 1.697 V to reach a current density of 100 mA cm⁻² superior to those of the CMOP∥CMOP (1.809 V), Ru-CMO∥Ru-CMO (1.846 V), and CMO∥CMO (1.929 V). Notably, the Ru-CMOP∥Ru-CMOP delivers high current densities of 200 and 500 mA cm⁻² achieved by a cell voltage of 1.748 and 1.828 V, respectively (FIG. 5B). Furthermore, the durability of this Ru-CMOP∥Ru-CMOP electrolyzer is examined at a high current density of 250 mA cm⁻². As a result, the CP curve illustrates that the Ru-CMOP∥Ru-CMOP couple maintains a steady cell voltage at 250 mA cm⁻² for 120 h (FIG. 5C), manifesting the robustness of Ru-CMOP for overall water splitting.

Moreover, the Ru-CMOP∥Ru-CMOP two-electrode device is integrated with a commercial silicon solar cell for solar-driven water electrolysis (FIG. 5D and FIG. 5E). The Ru-CMOP∥Ru-CMOP couple can be effectively powered by the solar panel at the potential real-time output of ˜2.00 V under sunlight irradiation with enormous bubbles violently emerging from both electrodes (FIG. 5F). Therefore, a solar cell-driven overall water-splitting device can be efficiently and robustly achieved by the Ru-CMOP couple, demonstrating that the Ru-CMOP possesses a good potential as a bifunctional electrocatalyst for industrial applications.

According to an aspect of the present disclosure, there is provided an electrolyzer including a cathode including Ru-CMOP and an anode including Ru-CMOP. In an example, the electrolyzer further includes a solar cell. Non-limiting examples of a solar cell include amorphous silicon solar cell, thin-film solar cell, perovskite solar cell, and the like.

In an example, the electrolyzer includes a catalyst as described hereinabove. In another example, the electrolyzer includes a catalyst made by the method described hereinabove. In yet another example, the catalyst includes Ru-CMOP as described hereinabove. In still another example, the Ru-CMOP includes a support, a plurality of Ru-doped CoMoO₄ nanosheet arrays (Ru-CMO) assembled on the support; and a plurality of phosphide nanodomains (Ru-CMP) on the Ru-doped CoMoO₄ nanosheet arrays.

In an example, the Ru-CMOP of the electrolyzer described hereinabove exhibits (i) overpotentials of about 114+5 mV at −100 mA cm⁻² and about 183+10 mV at −500 mA cm⁻² for hydrogen evolution reaction; and (ii) overpotentials of about 286+5 mV at 100 mA cm⁻² and about 351+10 mV at 500 mA cm⁻² for oxygen evolution reaction. In another example, the Ru-CMOP of the electrolyzer described hereinabove is durable at about 250+10 mA cm⁻² for about 100 to 120 hours, including all ranges, subranges, and values therein, e.g., about 100 hours to about 110 hours, about 110 hours to about 120 hours, about 100 hours to about 105 hours, about 105 hours to about 110 hours, about 110 hours to about 115 hours, about 115 hours to about 120 hours, about 100 hours, about 102 hours, about 105 hours, about 110 hours, about 116 hours, about 120 hours, etc.

### EXAMPLES

### Chemicals and Materials

In an example, cobalt nitrate hexahydrate (Co(NO₃)₂·6H₂O), ammonium molybdate tetrahydrate ((NH₄)₆Mo₇O₂₄·4H₂O), urea (CO(NH₂)₂), and potassium hydroxide (KOH) were purchased from Meryer Chemical Technology CO., Ltd. Ruthenium trichloride hydrate (RuCl₃·ₓH₂O) and sodium dihydrogen hypophosphite (NaH₂PO₂) were purchased from Sigma-Aldrich Co., Ltd. Nickel foam (NF) was purchased from Fuel Cell Store Co. All the chemicals that were used are analytic grade or better and were used as received without any further purification. Deionized water (DI water) used in the experiments was obtained from local sources.

### Synthesis of Ru-CMO

The ruthenium (Ru) doped CoMoO₄ nanosheet arrays (Ru-CMO) supported on NF were synthesized by a facile solvothermal method. The commercial NF was cut into a rectangular shape, with the size of 1×3 cm². The pieces of NF were sequentially cleaned in HCl (2 M), acetone, ethanol, and DI water for 15 min by sonication. 0.75 mmol of Co(NO₃)₂·6H₂O, 0.25 mmol of (NH₄)₆Mo₇O₂₄·4H₂O, 5 mmol of CO(NH₂)₂. 10 μL of RuCl₃·ₓH₂O solution (2 mg/mL) were added into 25 mL of DI water. After being stirred for 1 h, the obtained homogenous solution was transferred into a 50 mL Teflon-lined autoclave with a piece of tailored NF tilted in the autoclave, which was then sealed and heated at 180° C. for 12 h. After cooling to room temperature, the NF was taken out by a tweezer, rinsed with water thoroughly, and dried at 60° C. in an oven overnight.

### Synthesis of Ru-CMOP

NaH₂PO₂ powder in a quartz boat was placed at the upstream side of the furnace with a mass loading of 100 mg. The NF loaded by Ru-CMO precursor was placed at the downstream side of the furnace. Then, the samples were annealed at 300° C. for 2 h under Ar atmosphere at a ramping rate of 5° C. min⁻¹. After the furnace naturally cooled down to room temperature, the final material for Ru doped CoMoP (Ru-CMP) generated on the Ru-CMO nanosheets was obtained, which was denoted as Ru-CMOP.

### Synthesis of CMO

The synthesis procedure of pure CoMoO₄ nanosheet arrays (CMO) supported on NF was the same as that of Ru-CMO except for no addition of RuCl₃·ₓH₂O.

### Synthesis of CMOP

The synthesis procedure of CMOP was the same as that of Ru-CMOP except for using CMO as a precursor to replace the Ru-CMOP.

### Characterizations

The scanning electron microscopy (SEM) was carried out on the FEI Quanta 450 equipment. The transmission electron microscopy (TEM), high-resolution TEM (HRTEM), high-angle annular dark-field scanning TEM (HAADF-STEM), selected-area electron diffraction (SAED), and elements mapping analysis were conducted by using a JEM-2100F instrument at an accelerating voltage of 200 kV. X-ray diffraction (XRD) patterns were collected on a Bruker D8 Advance powder diffractometer. X-ray photoelectron spectroscopy (XPS) was recorded by Thermo Fisher ESCALAB 250Xi equipment. Depth-profiling XPS spectra were conducted via argon sputtering (3 kV, 2 μA energy). All binding energies were calibrated by the C 1 s peak at 284.6 eV. Raman measurement was carried out on a WITec alpha300 R Raman System with a laser wavelength of 532 nm.

### Electrochemical tests

All electrochemical measurements were conducted by a standard three-electrode setup on an electrochemical workstation (CHI 760E). The electrolyte was 1 M KOH (pH=13.8). The sample on NF was directly used as a working electrode. The geometric surface area of 0.5 cm² (i.e., 0.5 cm×1 cm) was immersed into the electrolyte. An Ag/AgCl electrode and a graphite rod were employed as reference and counter electrodes, respectively. For the Pt/C and RuO₂ powder as benchmark samples, 5 mg Pt/C (commercial 20% Pt/C) or 5 mg RuO₂ was dispersed in a mixture of 50 μL Nafion solution (5 wt %) and 450 μL ethanol under sonication for 2 h to form a homogeneous ink. Then, 50 μL ink was drop-casted onto the surface of NF (0.5 cm×1 cm) with a mass loading of 1 mg cm⁻² for Pt/C or RuO₂ and dried at ambient temperature.

Before the electrochemical measurement, the electrolyte was bubbled with Ar flow for 30 min and the catalysts were activated with numerous cyclic voltammetry (CV) cycles until they were stable. The linear sweep voltammetry (LSV) curves for HER and OER were measured at a scan rate of 5 mV s⁻¹. All polarization curves were exhibited with iR correction unless otherwise mentioned. iR correction was conducted by the formula: E_{iR}=E₀−i×Rₛ, where the solution resistance (i.e., Rₛ) was measured through electrochemical impedance spectroscopy (EIS). EIS measurement was conducted from 0.01 to 100000 Hz with an amplitude of 5 mV at −0.14 V vs. RHE for HER and at 1.51 V vs. RHE for OER. CV curves were collected at different scan rates (i.e., 20, 40, 60, 80, and 100 mV s⁻¹) in the potential range of 0.10 to 0.20 vs. RHE to evaluate the double-layer capacitance (C_{dl}) values for HER and from 1.00 to 1.10 vs. RHE for OER. The long-term stability of catalysts was evaluated using the chronopotentiometry (CP) test at −250 mA cm⁻² for HER and at 250 mA cm⁻² for OER without iR compensation. Besides, the overall water splitting performance was evaluated in 1 M KOH using a two-electrode configuration. For overall water splitting, the long-term stability test was evaluated by CP test at 250 mA cm⁻² without iR compensation. During these long-term CP tests, 1 mL of electrolyte was periodically added into the system for the compensation of water consumption for every 24 h. All potentials were normalized to the RHE according to the Nernst equation: E (vs. RHE)=E (vs. Ag/AgCl)+0.197 V+0.0591 V×pH.

### Theoretical Computation Details

The first-principal calculation based on density functional theory is realized by the Vienna Ab-initio Simulation Package (VASP) code [Perdew, J. P.; Burke, K.; Ernzerhof, M., Generalized Gradient Approximation Made Simple. Phys. Rev. Lett. 1996, 77 (18), 3865-3868 and Kresse, G.; Furthmüller, J., Efficient Iterative Schemes for Ab Initio Total-Energy Calculations Using a Plane-Wave Basis Set. Phys. Rev. B 1996, 54 (16), 11169-11186] with the full-potential projected augmented wave (PAW) formalism [Blöchl, P. E., Projector Augmented-Wave Method. Phys. Rev. B 1994, 50 (24), 17953-17979]. The exchange-functional is treated using the generalized gradient approximation (GGA) of Perdew-Burke-Ernzerhof (PBE) functional [Kresse, G.; Joubert, D., From Ultrasoft Pseudopotentials to the Projector Augmented-Wave Method. Phys. Rev. B 1999, 59 (3), 1758-1775]. Grimme's DFT-D2 functional is used to evaluate the dispersive van der Waals interactions between composites. A vacuum layer of 20 Å is applied to avoid perturbations from neighboring layers. The cut-off energy for the plane-wave expansion is set to 450 eV. A convergence criterion of 10-5 eV is set for self-consistence and the structure is relaxed until the maximum stress on each atom is lower than 0.01 eV/Å. The Γ-centered k-point mesh of 5×5×1 is used for density of states (DOS) calculation. Due to the inaccuracy of exchange-correction potential in dealing with d electrons of transitional metals, the Hubbard corrections (DFT+U) is employed. The U values are 4.41, 4.50, and 4.00 for Co, Mo, and Ru elements, respectively.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to an amount that is within ±10% of the recited value, an amount that is within ±5% of the recited value, less than or equal to ±2%, an amount that is within ±1% of the recited value, an amount that is within ±0.5% of the recited value, an amount that is within ±0.2% of the recited value, an amount that is within ±0.1% of the recited value, or an amount that is within ±0.05% of the recited value. In some instances, the approximating language may correspond to the precision of an instrument for measuring the value.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present disclosure have been described and depicted herein, alternative aspects and embodiments may be affected by persons having ordinary skill in the art to accomplish the same objectives. Accordingly, this disclosure and the appended claims are intended to cover all such further and alternative aspects and embodiments as fall within the true spirit and scope of the present disclosure.

What is claimed is:

1. A method of making a catalyst, comprising:
forming a plurality of Ru-doped CoMoO₄ nanosheets on a support by a solvothermal process; and
treating the plurality of Ru-doped CoMoO₄ nanosheets with a phosphorous source to create phosphide nanodomains,
wherein the solvothermal process comprises:
providing a support;
mixing a Co source, a Mo source, and a Ru source to form a first solution;
heating the solution and support together at a temperature in the range from about 160 to 180° C. for about 10 to 12 hours; and
cooling the supported CoMoO₄ nanosheets to room temperature.

2. The method of claim 1, wherein the support is a nickel foam or a carbon fiber paper.

3. The method of claim 1, wherein the Co source is water-soluble cobalt salt.

4. The method of claim 1, wherein the Co source is cobalt nitrate hexahydrate (Co(NO₃)₂·6H₂O).

5. The method of claim 1, wherein the Mo source is a water-soluble molybdate salt.

6. The method of claim 1, wherein the Mo source is ammonium molybdate tetrahydrate ((NH₄)₆Mo₇O₂₄·4H₂O).

7. The method of claim 1, wherein the Ru source is ruthenium chloride hydrate (RuCl₃·ₓH₂O).

8. The method of claim 1, wherein treating comprises annealing the supported Ru-doped CoMoO₄ nanosheets and a phosphorous source at a temperature in the range from about 280 to 300° C. for about 1 to 2 hours under Ar atmosphere at a ramping rate of about 5° C. min⁻¹ and cooling to room temperature.

9. The method of claim 1, wherein the phosphorous source is a hypophosphite.

10. The method of claim 1, wherein the phosphorous source is sodium hypophosphite NaH₂PO₂.

11. The method of claim 1, wherein the phosphide nanodomains have an average diameter of about 4 to about 8 nm.

12. The method of claim 1, wherein the treated Ru-doped CoMoO₄ nanosheet array has a thickness of about 10 to 15 nm.

13. A catalyst comprising:
a support;
a plurality of Ru-doped CoMoO₄ nanosheet arrays assembled on the support; and
a plurality of phosphide nanodomains on the Ru-doped CoMoO₄ nanosheet arrays.

14. The catalyst of claim 4, wherein
(i) the support is a nickel foam or a carbon fiber paper;
(ii) the phosphide nanodomains have an average diameter of about 4 to 8 nm; and
(iii) the catalyst has a thickness of about 10 to 15 nm.

15. An electrolyzer comprising:
a cathode comprising Ru-CMOP; and
an anode comprising Ru-CMOP.

16. The electrolyzer of claim 14, further comprising a solar cell.

17. The electrolyzer of claim 14, wherein the Ru-CMOP comprises:
a support;
a plurality of Ru-doped CoMoO₄ nanosheet arrays assembled on the support; and
a plurality of phosphide nanodomains on the Ru-doped CoMoO₄ nanosheet arrays.

18. The electrolyzer of claim 16, wherein
(i) the support is a nickel foam or a carbon fiber paper;
(ii) the phosphide nanodomains have an average diameter of about 4 to 8 nm; and
(iii) the catalyst has a thickness of about 10 to 15 nm.

19. The electrolyzer of claim 14, wherein the Ru-CMOP exhibits (i) overpotentials of about 114±5 mV at −100 mA cm⁻² and about 183±10 mV at −500 mA cm⁻² for hydrogen evolution reaction; and (ii) overpotentials of about 286±5 mV at 100 mA cm⁻² and about 351±10 mV at 500 mA cm⁻² for oxygen evolution reaction.

20. The electrolyzer of claim 14, wherein the Ru-CMOP is durable at about 250+10 mA cm⁻² for about 100 to 120 hours.
